(19) United States
(12) Patent Application Publication
(10) Pub. No.: US 2026/0342418 A1
(43) Pub. Date: Oct. 29, 2026

(54) METHODS AND SYSTEMS FOR ENHANCED BEAM MANAGEMENT FOR MULTIPLE TRANSMISSION AND RECEPTION POINTS

(71) Applicant: Apple Inc., Cupertino, CA (US)

(72) Inventors: Hong He, San Jose, CA (US); Dawei Zhang, Saratoga, CA (US); Wei Zeng, Saratoga, CA (US); Haitong Sun; Chunhai Yao, Beijing (CN); Chunxuan Ye, San Diego, CA (US); Jie Cui, San Jose, CA (US); Ankit Bhamri, Bad Nauheim (DE); Seyed Ali Akbar Fakoorian, San Diego, CA (US); Oghenekome Oteri, San Diego, CA (US)

(21) Appl. No.: 19/114,319

(22) PCT Filed: Sep. 30, 2022
(86) PCT No.: PCT/CN2022/123207

§ 371 Date: Mar. 21, 2025

(51) Int. Cl. H04B 7/06; H04L 5/00

(52) U.S. Cl. CPC H04B 7/06952; H04B 7/0626; H04L 5/0044

(57) ABSTRACT

A user equipment (UE) includes at least one transceiver, multiple antenna panels, and a processor configured to connect, via the at least one transceiver and using the multiple antenna panels, with multiple transmission and reception points (mTRP) for simultaneous uplink transmission over multiple panels (STxMP). The processor is configured to transmit, to at least one TRP, a UE capability report including one or more UE capabilities corresponding to each antenna panel of the multiple antenna panels for the STxMP. In accordance with the STxMP and group based beam reporting enabled at the UE, the processor is configured to transmit, to the at least one TRP of the mTRP, channel state information (CSI) report including at least one UE capability index identifying one UE capability corresponding to each antenna panel or antenna port of the multiple antenna panels or antenna ports for the STxMP.

### TECHNICAL FIELD

This application relates generally to wireless communication systems, including methods and systems for enhanced beam management for simultaneous uplink transmission over multiple panels (STxMP) with multiple transmission and reception point (mTRP).

### BACKGROUND

Wireless mobile communication technology uses various standards and protocols to transmit data between a network device (e.g., a base station) and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a network device of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the network device and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A network device used by a RAN may correspond to that RAN. One example of an E-UTRAN network device is an Evolved Universal Terrestrial Radio Access Network (E-UTRAN) Node B (also commonly denoted as evolved Node B, enhanced Node B, eNodeB, or eNB). One example of an NG-RAN network device is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIG. 2 illustrates an example message flow between a network device of a RAN and a user equipment (UE), according to embodiments described herein.

FIG. 3 illustrates an example of a SRS resource set indicator for various modes, according to embodiments described herein.

FIG. 4 illustrates an example flow-chart of operations that may be performed by a UE, according to embodiments described herein.

FIG. 5 illustrates another example flow-chart of operations that may be performed by the UE, according to embodiments described herein.

FIG. 6 illustrates an example flow-chart of operations that may be performed by a network device of a RAN, according to embodiments described herein.

FIG. 7 illustrates an example architecture of a wireless communication system, according to embodiments described herein.

FIG. 8 illustrates a system for performing signaling between a wireless device and a network device, according to embodiments described herein.

### DETAILED DESCRIPTION

Various embodiments described in the present disclosure are related to improving a unified transmission configuration indicator (TCI) framework of 3GPP Rel-17 by extending it for multiple transmission and reception point (mTRP) use cases. In particular, various embodiments are directed to solutions for various open issues to enable simultaneous uplink transmission over multiple panels (STxP) for mTRP.

For example, one open issue for STxMP for mTRP is how to use panel capability aware beam reporting for STxMP. In 3GPP Rel-17, a panel capability aware beam reporting is used to support a fast uplink (UL) beam and panel selection for UL (or a codebook based physical uplink shared channel (PUSCH)) transmission using a single panel. Accordingly, various embodiments, as described herein, provide enhancements to UE capability reporting to support STxMP using multiple panels with mTRP.

Another open issue for STxMP for mTRP is how to support dynamic switching between a single transmission and reception point (sTRP) and a mTRP for UL transmission. Further, in a multi-beam operation, a newly identified beam is applied to all channels upon receiving a beam failure recovery response (BFRR), which is improper in mTRP use cases. Various embodiments in the present disclosure provide solutions for dynamically switching between a sTRP and a mTRP for UL transmission via a new signaling design that takes into account a maximum number of layers (or ranks) requirement for UL transmission for the sTRP and mTRP. Further, various embodiments described herein provide methods to apply a beam update on a per transmission and reception point (TRP) basis after recovery of a beam failure (or a beam failure recovery (BFR)).

Reference will now be made in detail to representative embodiments/aspects illustrated in the accompanying drawings. The following description is not intended to limit the embodiments to one preferred embodiment. On the contrary, it is intended to cover alternatives, combinations, modifications, and equivalents as can be included within the spirit and scope of the described embodiments as defined by the appended claims.

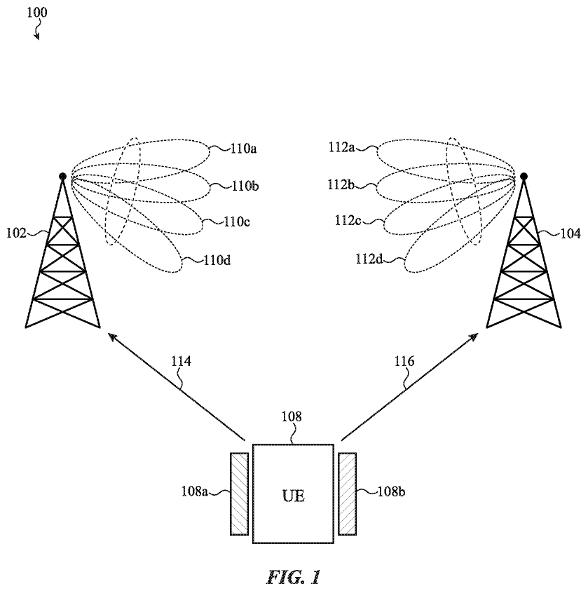

FIG. 1 shows an example wireless communication system, according to embodiments described herein. As shown in FIG. 1, a wireless communication system 100 may include a network device of a RAN 102, a network device of a RAN 104, and a user equipment (UE) 108. The UE 108 may perform UL transmission 114 to the TRP 102 via an antenna panel (or an antenna port) 108a of the UE, and UL transmission 116 to the TRP 104 via an antenna panel (or an antenna port) 108b of the UE 108. In other words, the UE 108 may perform STxMP with the network devices 102 and 104 via multiple antenna panels (antenna ports).

In some embodiments, the network devices 102 and 104 may be an eNb, an eNodeB, a gNodeB, or an access point (AP) in a radio access network (RAN) and may support one or more radio access technologies, such as 4G, 5G, 5G new radio (5G NR), and so on. The UE 108 may be a phone, a smart phone, a tablet, a smartwatch, an Internet-of-Things (IoT), a vehicle, and so on. By way of a non-limiting example, each network device of the network devices 102 and 104 may serve as a TRP for communication with the UE 108 in a UL direction and a DL direction. The UE 108 may use one or more antenna panels 108a and 108b to alternately, simultaneously, or contemporaneously send UL transmissions of data and/or control information, such as PUCCH, PUSCH, or SRS, to one or more TRPs, and DL reception of the data and/or control information, such as PDCCH, PDSCH, and so on.

As shown in FIG. 1, in some embodiments, and by way of a non-limiting example, the network device (or the first TRP) 102 may transmit multiple channel state information reference signal (CSI-RS) beams 110a, 110b, 110c, and/or 110d, which are associated with CSI-RS resource indicator (CRI) numbers CRI #23, CRI #14, CRI #11, and CRI #31, respectively. Similarly, the network device (or the second TRP) 104 may transmit multiple CSI-RS beams 112a, 112b, 112c, and/or 112d, which are associated with CRI numbers CRI #43, CRI #22, CRI #12, and CRI #32, respectively. CRI numbers and/or the number of CSI-RS beams for each of the first TRP 102 and the second TRP 104 are for example only. Accordingly, different CRI numbers and/or a different number of CSI-RS beams may be used by each TRP than shown here in FIG. 1.

In some embodiments, a panel capability aware beam reporting to support a fast uplink (UL) beam and panel selection for UL (or a codebook based physical uplink shared channel (PUSCH)) transmission using multiple antenna panels or antenna ports for STxMP may be made possible by a UE reporting a new UE capability information to one or more TRPs of mTRP. The new UE capability information may include information regarding whether ranks or layers supported by the UE for PUSCH transmission are shared across two panels and/or how the ranks or layers are shared. By way of a non-limiting example, in some embodiments, the maximum number of ranks or layers supported at the UE across all panels may be up to four layers, and a total number of codewords may be up to two layers across all panels.

Accordingly, the new UE capability information may include a list of a maximum (number of) ranks or layers, or a maximum number of sounding reference signal (SRS) ports for a UL transmission (or a PUSCH transmission) corresponding to a first SRS resource set and a second SRS resource set. By way of a non-limiting example, the new UE capability information may be reported through a UE capability report. Thus, the UE capability report may include one or more UE capabilities corresponding to each antenna panel or antenna port of the multiple antenna panels or antenna ports for the STxMP. The list of maximum (number of) ranks or layers may correspond with UE capability for a single panel for UL transmission with a sTRP and UE capability for two panels for STxMIP operation.

An example ASN.1 code for STxMP operation may be as follows:

```
      SupportedLayerCombination-r18 ::= SEQUENCE (SIZE (1 ... maxLayerComb-r10))
OF
      LayerCombinationParameters-r18
      LayerCombinationParamaters-r18 ::= SEQUENCE {
          maxRank INTEGER (1..4) OPTIONAL, -- Cond codebookBased
          maxRank2 INTEGER (1..4) OPTIONAL, -- Cond codebookBased
      }
```

maxRank may indicate a maximum number of layers supported for the PUSCH transmission associated with a first set of a SRS resource set, and maxRank2 may indicate a maximum number of layers supported for the PUSCH transmission associated with a second set of the SRS resource set.

The UE capability report may be based on a configuration, such as a CSI-ReportConfig, received from a network (e.g., a radio access network, and/or a core network) via one or more network devices (TRPs). An example of CSI-ReportConfig may be as follows:

| CSI-ReportConfig :== SEQUENCE { | |
|---|---|
| reportConfigId CSI-ReportConfigId, | |
| ... | |
| reportQuantity-r18 CHOICE { | |
| cri-RSRP-CapabilityIndex-r18 | NULL, |
| cri-RSRP-CapabilityIndex2-r18 | NULL, |
| cri-RSRP-CapabilityCombIndex-r18 | NULL, |
| ssb-Index-RSRP-CapabilityIndex-r18 | NULL, |
| ssb-Index-RSRP-CapabilityIndex2-r18 | NULL, |
| ssb-Index-RSRP-CapabilityCombIndex-r18 | NULL, |
| cri-SINR-CapabilityIndex-r18 | NULL, |
| cri-SINR-CapabilityIndex2-r18 | NULL, |
| cri-SINR-CapabilityCombIndex-r18 | NULL, |
| ssb-Index-SINR-CapabilityIndex-r18 | NULL, |
| ssb-Index-SINR-CapabilityIndex2-r18 | NULL, |
| ssb-Index-SINR-CapabilityCombIndex-r18 | NULL, |
| } OPTIONAL - Need R | |

In the example CSI-ReportConfig, cri-RSRP-CapabilityIndex-r18, ssb-Index-RSRP-CapabilityIndex-r18, cri-SINR-CapabilityIndex-r18, and ssb-Index-SINR-CapabilityIndex-r18 may indicate the supported capability index of LayerCombinationParameters capabilities reported by the UE for the first SRS resource set only for UL transmission with a sTRP. Similarly, cri-RSRP-CapabilityIndex2-r18, ssb-Index-RSRP-CapabilityIndex2-r18, cri-SINR-CapabilityIndex2-r18, and ssb-Index-SINR-CapabilityIndex2-r18 may indicate the supported capability index of LayerCombinationParameters capabilities reported by the UE for the second SRS resource set only for UL transmission with a sTRP. In the example CSI-ReportConfig, cri-RSRP-CapabilityCombIndex-r18, ssb-Index-RSRP-CapabilityCombIndex-r18, cri-SINR-CapabilityCombIndex-r18, and ssb-Index-SINR-CapabilityCombIndex-r18 may indicate the supported capability index of LayerCombinationParameters capabilities reported by the UE for the first and the second SRS resource sets for STxMP.

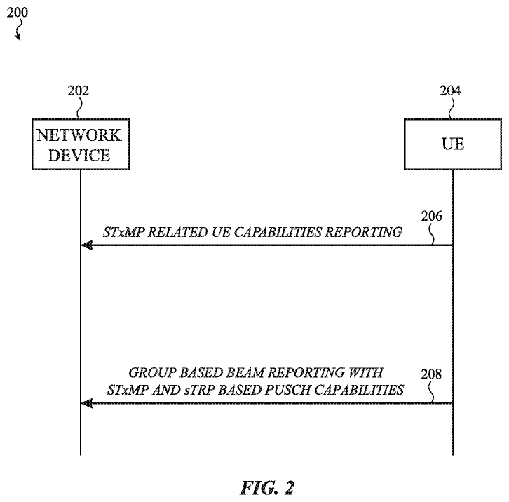

In some embodiments, the new UE capability information, as described herein, may be reported by a UE to a TRP (or a network device) as shown in FIG. 2. As shown in FIG. 2, a message flow diagram 200 indicates messages exchanged between a TRP (or a network device) 202 and a UE 204. The UE 204 may report to the TRP 202 STxMP related UE capabilities 206. STxP related UE capabilities 206 may be reported using LayerCombinationParameters, as described herein, for the first and second sets of SRS resource sets.

By way of a non-limiting example, STxMP related UE capabilities 206 may include four indexes, such as indexes 0, 1, 2, and 3, which may be associated with a first SRS resource set and/or a second SRS resource set, as shown in a table below.

| LayerCombinationParameters | | | |
|---|---|---|---|
| List Index | maxRank | maxRank2 | STRP/mTRP |
| 0 | 4 | Absent | STRP, SRS |
| | | | Resource Set 1 |
| 1 | Absent | 2 | STRP, SRS |
| | | | Resource Set 2 |
| 2 | 2 | 2 | STxMP for mTRP |
| 3 | 3 | 1 | STxMP for mTRP |

In some embodiments, LayerCombinationParameters list index in the table above may be selected from indexes configured at the UE using the CSI-ReportConfig shown herein. As shown in the table above, the UE capability index 0 and the UE capability index 1 may be reported for sTRP cases. Further, the UE capability index 0 may be associated with a first UL panel that supports 4 layers or ranks for PUSCH. The UE capability index 0 may also be associated with a first SRS resource set that corresponds with a first TRP. The UE capability index 1 may be associated with a second UL panel that supports 2 layers or ranks for PUSCH. The UE capability index 1 may also be associated with a second SRS resource set that corresponds with a second TRP. Thus, a UE capability of one or more UE capabilities may be identified by a respective UE capability index.

The UE capability index 2 may be associated with a first UL panel that supports 2 layers and a second UL panel that supports 2 layers. The first UL panel may be associated with a first TRP and the second UL panel may be associated with a second TRP. The UE capability index 2 may thus be related to STxMP. Like UE capability index 2, a UE capability index 3 may be associated with a first UL panel that supports 2 layers and a second UL panel that supports 1 layer. The first UL panel may be associated with a first TRP and the second UL panel may be associated with a second TRP. The UE capability index 3 may thus be related to STxP.

Accordingly, in some embodiments, each UE capability index may be associated with a unique combination of a maximum number of layers supported for uplink (UL) transmission associated with a SRS resource set. Further, one or more UE capability indexes may be configured or preconfigured at the UE via a radio resource control (RRC) signaling.

In some embodiments, and by way of a non-limiting example, a UE may be configured for STxMP and group based beam reporting. In a group based beam reporting, multiple beams of a TRP are managed in a group basis rather than in a beam-by-beam basis. Accordingly when group based beam reporting is configured at the UE, the UE may report in UE capabilities indices of maximum layers combinations in a single reporting instance, which is shown in FIG. 2 as 208. In other words, a list of UE capability indexes is reported by the UE to a network (or a network device). The maximum layers combinations may correspond with at least one capability corresponding to one SRS resource set for sTRP and one capability corresponding to two SRS resource sets for STxP. The UE may report two CRI-RSRPs for the first TRP and the second TRP together with the supported UE capabilities for UL transmission with the sTRP and the mTRP (for STxMP). By way of a non-limiting example, two CRI-RSRPs for the first TRP and the second TRP may be reported by the UE in a CSI report.

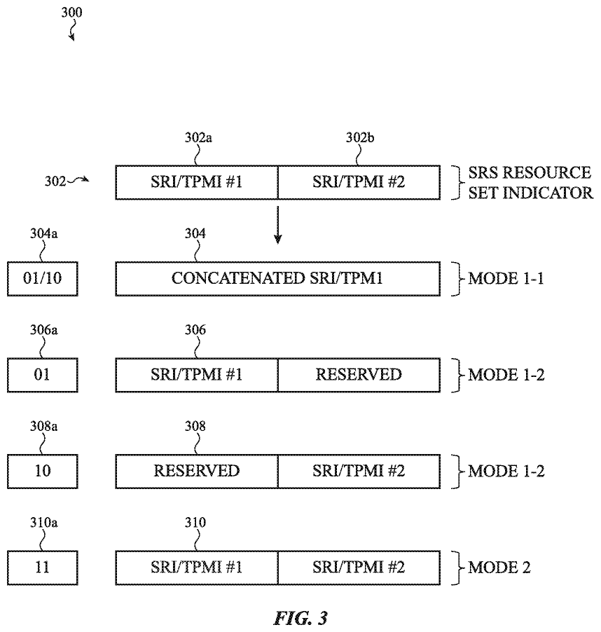

In some embodiments, a UE that is capable to support UL transmission with a sTRP and also a STxMP with the mTRP, a UE may dynamically switch between UL transmission with the sTRP and the mTRP. FIG. 3 illustrates an example of a SRS resource set indicator for dynamic switching between UL transmission with the sTRP and the mTRP.

As described herein, a UE may be configured with two SRS resource sets for UL transmission (e.g., STxP), and each SRS resource set of the two SRS resource sets may be associated with one UL panel. STxP may be associated with contention-based (CB) UL transmission and/or non-CB based UL transmission. Accordingly, which SRS resource set (or a corresponding UL panel) of each SRS resource set (or UL panels) is being used for UL transmission may be represented using a bit of a SRS resource set indicator field's value. The SRS resource set indicator field may be of two-bits length, if there are two UL panels. A value of the SRS resource set indicator field and its corresponding interpretation may be as specified in the table below:

| Value of SRS | | |
|---|---|---|
| Resource Set | | STRP/ |
| Indicator | Description | mTRP |
| 00 | Reserved | Reserved |
| 01 | an UL panel associated | STRP |
| | with a first SRS | |
| | resource set is selected | |
| | for UL transmission | |
| 10 | an UL panel associated | STRP |
| | with a second SRS | |
| | resource set is selected | |
| | for UL transmission | |
| 11 | UL panels associated the | mTRP |
| | first and the second | |
| | SRS resource sets | |
| | are selected for UL | |
| | transmission | |

In some embodiments, and by way of a non-limiting example, a SRS resource set may further be associated with a higher layer parameter maxRank and/or maxRank2 described herein using a radio resource control (RRC) signaling. Further, the SRS resource set may be used to determine a transmit precoding matrix index (TPMI) and/or a size of the TPMI corresponding to each UL panel as required for scheduling UL transmission.

Accordingly, a switching between UL transmission with the sTRP and UL transmission with the mTRP may be dynamically indicated, as shown in the table above, by using a value ‘01’ (a UL panel associated with the first SRS resource set is selected), a value ‘10’ (a UL panel associated with the second SRS resource set is selected), and/or a value ‘11’ (two UL panels and their corresponding SRS resource sets are selected for STxMP).

In some embodiments, and by way of a non-limiting example, a value ‘00’ for a SRS resource set indicator may indicate UL panels associated with the first and the second SRS resource sets are selected for STxMP, in which the first SRS Resource Set Indicator (SRI) or TPMI may be associated with the first TRP, and the second SRI or TPMI may be associated with the second TRP. Further, a value ‘11’ for the SRS resource set indicator may indicate UL panels associated with the first and the second SRS resource sets are selected for STxMP, in which the first SRS Resource Set Indicator (SRI) or TPMI may be associated with the second TRP, and the second SRI or TPMI may be associated with the first TRP.

In some embodiments, as shown in an information element diagram 300 of an SRS resource set indicator 302, the SRS resource set indicator 302 may represent a SRI or TPMI field or bit corresponding to a panel of a plurality of panels (e.g., two panels) for UL transmission as 302a and 302b. A size corresponding to each SRI or TPMI for a panel may be (semi-statically) determined based on the values of higher layer parameter maxRank or maxRank2 described herein for the corresponding SRS reset indicator's index value.

In some embodiments, UL transmission with sTRP and/or mTRP may be performed in accordance with a downlink control information (DCI) received at a UE. The DCI received at the UE may indicate whether the UL transmission is performed with sTRP or mTRP using the SRS resource set indicator. Accordingly, a SRS resource set indicator field 306 with value ‘01’ shown as 306a may indicate a SRS resource set indicator or TPMI associated with the first SRS resource set is selected, and a SRS resource set indicator field 308 with value ‘10’ shown as 308a may indicate a SRS resource set indicator or TPMI associated with the second SRS resource set is selected. The SRS resource set indicator fields 306 and 308 may be associated with a mode, e.g., mode1-2, in which each UL panel has their respective independent maximum number of layers or ranks.

However, if a maximum number of layers or ranks are shared across two panels, then as shown in FIG. 3 as mode1-1, a SRS resource set indicator field 304 may be a concatenated field using a SRI or TPMI corresponding to each UL panel concatenated, and may have a value ‘01’ or ‘10’ as 304a. A SRS resource set indicator field 310 with a value ‘11’ may correspond with a mode2, which corresponds with a STxMP using two panels. Accordingly, the SRS resource set indicator field 310 may specify a SRI or TPMI corresponding to two UL panels as a value ‘11’ shown in FIG. 3 as 310a.

In some embodiments, after beam failure recovery (BFR), a beam update may be applied on a per TRP basis, rather than applying a new identified beam to all channels upon receiving a BFRR. To enable a TRP-specific beam update after BFR and/or upon receiving a BFRR, a UE may be configured with a separate beam failure detection (BFD) reference signal (RS) set for each TRP. For example, a first BFD-RS set may be configured corresponding to a first TRP, and a second BFD-RS set may be configured corresponding to a second TRP. For each joint transmission control indicator (TCI)-state and UL TCI-state, a BFD-RS set may be associated with a particular TRP using a BFD-RS set index (e.g., a BFD-RS set index 0 may be associated with a first TRP and a BFD-RS set index 1 may be associated with a second TRP), a CORESET pool index (e.g., CORESET pool index 0 may be associated with a first TRP and a CORESET pool index 1 may be associated with a second TRP), an association of a BFD-RS set index, and a TRP ID (e.g., a TRP-ID 0 may be associated with a BFD-RS set index 0, and a TRP-ID 1 may be associated with a BFD-RS set index 1). In some embodiments, and by way of a non-limiting example, the UE may associate a BFD-RS set index based on a source RS of the TCI state. For example, if a source RS of a TCI state is a synchronization signal block (SSB) of a neighbor cell with an active physical cell ID (PCI) or channel state information reference signal (CSI-RS) with an RRC configured scrambling ID, then the particular neighbor cell (or a TRP) may be associated with a BFD-RS set index of value 1; otherwise, the BFD-RS set index value 0 may be associated with a source RS of a TCI state (or a TRP).

Various embodiments in the present disclosure are described assuming a UE with two panels and connected to two TRPs for STxMP. However, the UE may have more than two panels, and may be connected to more than two TRPs for STxMP. Accordingly, various embodiments described herein may be applied for STxMP using more than two panels and with more than two TRPs.

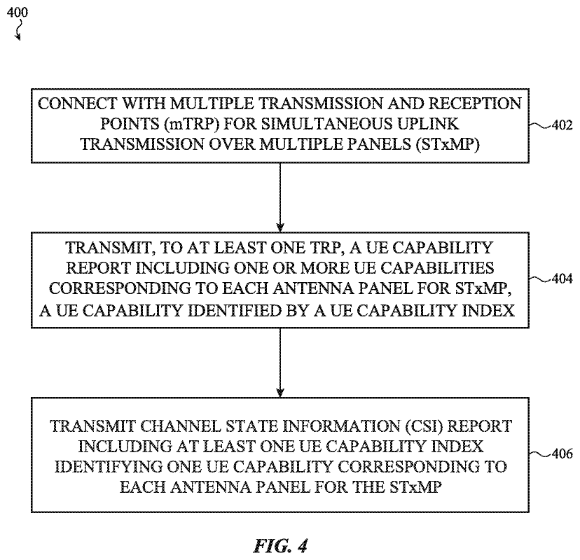

FIG. 4 illustrates an example flow-chart of operations that may be performed by a UE, according to embodiments described herein. As shown in a flow-chart 400, a UE may connect to with multiple TRPs for STxP at 402. The UE may be coupled with multiple network devices of a RAN for UL transmission using multiple antenna panels (or antenna ports) of the UE.

At 404, the UE may transmit a UE capability report including one or more UE capabilities corresponding to each antenna panel (or antenna port) of the multiple antenna panels (or antenna ports) for STxMP. The UE capability corresponding to each antenna panel (or antenna port) may be transmitted as UE capability information including ranks or layers supported by the UE for PUSCH transmission, and/or how the ranks or layers are shared across multiple antenna panels (or antenna ports), e.g., two antenna panels.

At 406, the UE may transmit channel state information (CSI) report to at least a TRP of the mTRP. The CSI report may be transmitted by the UE in accordance with the STxMP and group based beam reporting configuration of the UE. The CSI report may include at least one UE capability index, which describes or identifies (one) UE capability corresponding to each antenna panel (or antenna port) of the multiple antenna panels (or antenna ports). The UE capability index may correspond with a maximum number of layers supported for UL transmission associated with a first SRS resource set and a maximum number of layers supported for UL transmission associated with a second SRS resource set. By way of a non-limiting example, the first SRS resource set may be associated with a first TRP of multiple TRPs, and the second SRS resource set may be associated with a second TRP of the multiple TRPs. A total of the maximum number of layers supported for UL transmission associated with the first SRS resource set and the maximum number of layers supported for UL transmission associated with the second SRS resource set may be less than or equal to four layers.

Accordingly, the UE may indicate to the network its capability for STxP with mTRP, and support dynamic switching between UL transmission with sTRP and UL transmission with mTRP.

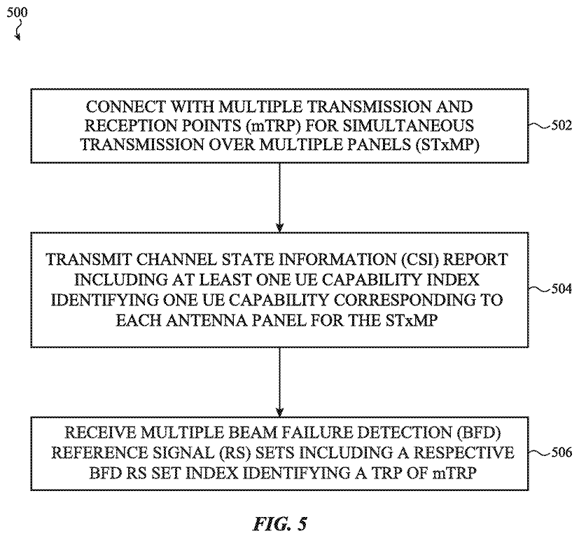

FIG. 5 illustrates another example flow-chart of operations that may be performed the UE, according to embodiments described herein. As shown in a flow-chart 500, a UE may connect with multiple TRPs for STxMP at 502. The UE may be coupled with multiple network devices of a RAN for UL transmission using multiple antenna panels (or antenna ports) of the UE.

At 504, the UE may transmit a UE capability report including one or more UE capabilities corresponding to each antenna panel (or antenna port) of the multiple antenna panels (or antenna ports) for STxMP. The UE capability corresponding to each antenna panel (or antenna port) may be transmitted as UE capability information including ranks or layers supported by the UE for PUSCH transmission, and/or how the ranks or layers are shared across multiple antenna panels (or antenna ports), e.g., two antenna panels.

At 506, the UE may receive, from a network device of a RAN, multiple beam failure detection (BFD) reference signal (RS) sets. Each BFD RS set of the multiple BFD RS sets may have a respective BFD RS set index. As described herein, the respective BFD RS set index may identify a TRP of mTRP, and accordingly a beam update corresponding to a new beam discovered upon BFR may be applied to the identified TRP. In other words, the UE may update TCI states corresponding to a TRP identified and/or associated with a BFD RS set index in the received BFRR from the network device.

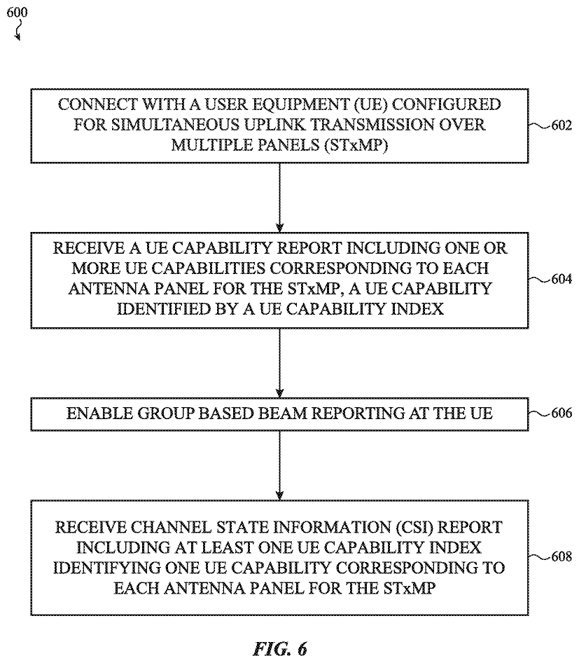

FIG. 6 illustrates an example flow-chart of operations that may be performed by a network device of a RAN, according to embodiments described herein. As shown in a flow-chart 600, a network device of a RAN may connect with a UE at 602. The UE may be connected with one or more other network devices for STxMP. At 604, the network device may receive from a UE, a UE capability report including one or more UE capabilities corresponding to each antenna panel (or antenna port) of the multiple antenna panels (or antenna ports) for STxMP. The UE capability corresponding to each antenna panel (or antenna port) may be transmitted as UE capability information including ranks or layers supported by the UE for PUSCH transmission, and/or how the ranks or layers are shared across multiple antenna panels (or antenna ports), e.g., two antenna panels. At 606, based on the UE capability report received at 604, the network device may enable group based beam reporting by the UE if the UE supports STxP based on the received UE capability at 604.

At 608, the network device may receive from the UE a channel state information (CSI) report. The CSI report may be transmitted by the UE in accordance with the STxMP and group based beam reporting configuration of the UE. The CSI report may include at least one UE capability index, which describes or identifies (one) UE capability corresponding to each antenna panel (or antenna port) of the multiple antenna panels (or antenna ports). The UE capability index may correspond with a maximum number of layers supported for UL transmission associated with a first SRS resource set and a maximum number of layers supported for UL transmission associated with a second SRS resource set. By way of a non-limiting example, the first SRS resource set may be associated with a first TRP of multiple TRPs, and the second SRS resource set may be associated with a second TRP of the multiple TRPs. A total of the maximum number of layers supported for UL transmission associated with the first SRS resource set and the maximum number of layers supported for UL transmission associated with the second SRS resource set may be less than or equal to four layers.

Embodiments contemplated herein include one or more non-transitory computer-readable media storing instructions to cause an electronic device, upon execution of the instructions by one or more processors of the electronic device, to perform one or more elements of the method 400, 500, or 600. In the context of method 400, or 500, this non-transitory computer-readable media may be, for example, a memory of a UE (such as a memory 806 of a wireless device 802 that is a UE, as described herein). In the context of method 600, this non-transitory computer-readable media may be, for example, a memory of a network device (such as a memory 824 of a network device 820, as described herein).

Embodiments contemplated herein include an apparatus having logic, modules, or circuitry to perform one or more elements of the method 400, 500, or 600. In the context of method 400, or 500, this apparatus may be, for example, an apparatus of a UE (such as a wireless device 802 that is a UE, as described herein). In the context of method 600, this apparatus may be, for example, an apparatus of a network device (such as a network device 820, as described herein).

Embodiments contemplated herein include an apparatus having one or more processors and one or more computer-readable media, using or storing instructions that, when executed by the one or more processors, cause the one or more processors to perform one or more elements of the method 400, 500, or 600. In the context of method 400, or 500, this apparatus may be, for example, an apparatus of a UE (such as a wireless device 802 that is a UE, as described herein). In the context of the method 600, this apparatus may be, for example, an apparatus of a network device (such as a network device 820, as described herein).

Embodiments contemplated herein include a signal as described in or related to one or more elements of the method 400, 500, or 600.

Embodiments contemplated herein include a computer program or computer program product having instructions, wherein execution of the program by a processor causes the processor to carry out one or more elements of the method 400, 500, or 600. In the context of method 400, or 500, the processor may be a processor of a UE (such as a processor(s) 804 of a wireless device 802 that is a UE, as described herein), and the instructions may be, for example, located in the processor and/or on a memory of the UE (such as a memory 806 of a wireless device 802 that is a UE, as described herein). In the context of method 600, the processor may be a processor of a network device (such as a processor(s) 822 of a network device 820, as described herein), and the instructions may be, for example, located in the processor and/or on a memory of the network device (such as a memory 824 of a network device 820, as described herein).

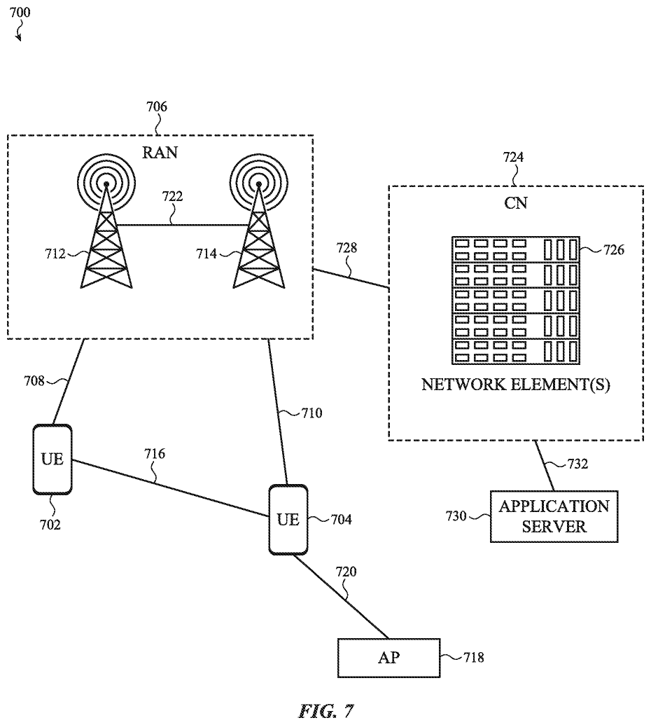

FIG. 7 illustrates an example architecture of a wireless communication system, according to embodiments described herein. The following description is provided for an example wireless communication system 700 that operates in conjunction with the LTE system standards and/or 5G or NR system standards as provided by 3GPP technical specifications.

As shown by FIG. 7, the wireless communication system 700 includes UE 702 and UE 704 (although any number of UEs may be used). In this example, the UE 702 and the UE 704 are illustrated as smartphones (e.g., handheld touchscreen mobile computing devices connectable to one or more cellular networks), but may also comprise any mobile or non-mobile computing device configured for wireless communication.

The UE 702 and UE 704 may be configured to communicatively couple with a RAN 706. In embodiments, the RAN 706 may be NG-RAN, E-UTRAN, etc. The UE 702 and UE 704 utilize connections (or channels) (shown as connection 708 and connection 710, respectively) with the RAN 706, each of which comprises a physical communications interface. The RAN 706 can include one or more network devices, such as base station 712 and base station 714, that enable the connection 708 and connection 710.

In this example, the connection 708 and connection 710 are air interfaces to enable such communicative coupling, and may be consistent with RAT(s) used by the RAN 706, such as, for example, an LTE and/or NR.

In some embodiments, the UE 702 and UE 704 may also directly exchange communication data via a sidelink interface 716. The UE 704 is shown to be configured to access an access point (shown as AP 718) via connection 720. By way of example, the connection 720 can comprise a local wireless connection, such as a connection consistent with any IEEE 802.11 protocol, wherein the AP 718 may comprise a Wi-Fi® router. In this example, the AP 718 may be connected to another network (for example, the Internet) without going through a CN 724.

In embodiments, the UE 702 and UE 704 can be configured to communicate using orthogonal frequency division multiplexing (OFDM) communication signals with each other or with the base station 712 and/or the base station 714 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 712 or base station 714 may be implemented as one or more software entities running on server computers as part of a virtual network. In addition, or in other embodiments, the base station 712 or base station 714 may be configured to communicate with one another via interface 722. In embodiments where the wireless communication system 700 is an LTE system (e.g., when the CN 724 is an EPC), the interface 722 may be an X2 interface. The X2 interface may be defined between two or more network devices of a RAN (e.g., two or more eNBs and the like) that connect to an EPC, and/or between two eNBs connecting to the EPC. In embodiments where the wireless communication system 800 is an NR system (e.g., when CN 724 is a 5GC), the interface 722 may be an Xn interface. The Xn interface is defined between two or more network devices of a RAN (e.g., two or more gNBs and the like) that connect to the 5GC, between a base station 712 (e.g., a gNB) connecting to the 5GC and an eNB, and/or between two eNBs connecting to the 5GC (e.g., CN 724).

The RAN 706 is shown to be communicatively coupled to the CN 724. The CN 724 may comprise one or more network elements 726, which are configured to offer various data and telecommunications services to customers/subscribers (e.g., users of UE 702 and UE 704) who are connected to the CN 724 via the RAN 706. The components of the CN 724 may be implemented in one physical device or separate physical devices including components to read and execute instructions from a machine-readable or computer-readable medium (e.g., a non-transitory machine-readable storage medium).

In embodiments, the CN 724 may be an EPC, and the RAN 706 may be connected with the CN 724 via an S1 interface 728. In embodiments, the S1 interface 728 may be split into two parts, an S1 user plane (S1-U) interface, which carries traffic data between the base station 712 or base station 714 and a serving gateway (S-GW), and the S1-MME interface, which is a signaling interface between the base station 712 or base station 714 and mobility management entities (MMEs).

In embodiments, the CN 724 may be a 5GC, and the RAN 706 may be connected with the CN 724 via an NG interface 728. In embodiments, the NG interface 728 may be split into two parts, an NG user plane (NG-U) interface, which carries traffic data between the base station 712 or base station 714 and a user plane function (UPF), and the S1 control plane (NG-C) interface, which is a signaling interface between the base station 712 or base station 714 and access and mobility management functions (AMFs).

Generally, an application server 730 may be an element offering applications that use internet protocol (IP) bearer resources with the CN 724 (e.g., packet switched data services). The application server 730 can also be configured to support one or more communication services (e.g., VoIP sessions, group communication sessions, etc.) for the UE 702 and UE 704 via the CN 724. The application server 730 may communicate with the CN 724 through an IP communications interface 732.

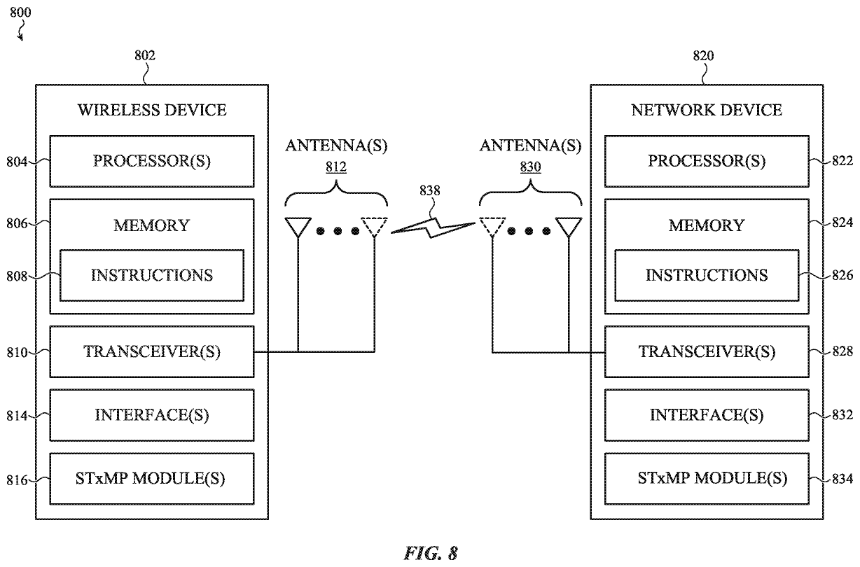

FIG. 8 illustrates a system 800 for performing signaling 838 between a wireless device 802 and a network device 820, according to embodiments described herein. The system 800 may be a portion of a wireless communication system as herein described. The wireless device 802 may be, for example, a UE of a wireless communication system. The network device 820 may be, for example, a base station (e.g., an eNB or a gNB) of a wireless communication system.

The wireless device 802 may include one or more processor(s) 804. The processor(s) 804 may execute instructions such that various operations of the wireless device 802 are performed, as described herein. The processor(s) 804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 802 may include a memory 806. The memory 806 may be a non-transitory computer-readable storage medium that stores instructions 808 (which may include, for example, the instructions being executed by the processor(s) 804). The instructions 808 may also be referred to as program code or a computer program. The memory 806 may also store data used by, and results computed by, the processor(s) 804.

The wireless device 802 may include one or more transceiver(s) 810 that may include radio frequency (RF) transmitter and/or receiver circuitry that use the antenna(s) 812 of the wireless device 802 to facilitate signaling (e.g., the signaling 838) to and/or from the wireless device 802 with other devices (e.g., the network device 820) according to corresponding RATs.

The wireless device 802 may include one or more antenna(s) 812 (e.g., one, two, four, or more). For embodiments with multiple antenna(s) 812, the wireless device 802 may leverage the spatial diversity of such multiple antenna(s) 812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 802 may be accomplished according to precoding (or digital beamforming) that is applied at the wireless device 802 that multiplexes the data streams across the antenna(s) 812 according to known or assumed channel characteristics such that each data stream is received with an appropriate signal strength relative to other streams and at a desired location in the spatial domain (e.g., the location of a receiver associated with that data stream). Some embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In some embodiments having multiple antennas, the wireless device 802 may implement analog beamforming techniques, whereby phases of the signals sent by the antenna(s) 812 are relatively adjusted such that the (joint) transmission of the antenna(s) 812 can be directed (this is sometimes referred to as beam steering).

The wireless device 802 may include one or more interface(s) 814. The interface(s) 814 may be used to provide input to or output from the wireless device 802. For example, a wireless device 802 that is a UE may include interface(s) 814 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 810/antenna(s) 812 already described) that allow for communication between the UE and other devices and may operate according to known protocols (e.g., Wi-Fi®, Bluetooth®, and the like).

The wireless device 802 may include an STxP module 816. The STxP module 816 may be implemented via hardware, software, or combinations thereof. For example, the STxMP module 816 may be implemented as a processor, circuit, and/or instructions 808 stored in the memory 806 and executed by the processor(s) 804. In some examples, the STxMP module 816 may be integrated within the processor(s) 804 and/or the transceiver(s) 810. For example, the STxMP module 816 may be implemented by a combination of software components (e.g., executed by a DSP or a general processor) and hardware components (e.g., logic gates and circuitry) within the processor(s) 804 or the transceiver(s) 810.

The STxMP module 816 may be used for various aspects of the present disclosure, for example, aspects of FIGS. 1-6, from a UE perspective.

The network device 820 may include one or more processor(s) 822. The processor(s) 822 may execute instructions such that various operations of the network device 820 are performed, as described herein. The processor(s) 822 may include one or more baseband processors implemented using, for example, a CPU, a DSP, an ASIC, a controller, an FPGA device, another hardware device, a firmware device, or any combination thereof configured to perform the operations described herein.

The network device 820 may include a memory 824. The memory 824 may be a non-transitory computer-readable storage medium that stores instructions 826 (which may include, for example, the instructions being executed by the processor(s) 822). The instructions 826 may also be referred to as program code or a computer program. The memory 824 may also store data used by, and results computed by, the processor(s) 822.

The network device 820 may include one or more transceiver(s) 828 that may include RF transmitter and/or receiver circuitry that use the antenna(s) 830 of the network device 820 to facilitate signaling (e.g., the signaling 838) to and/or from the network device 820 with other devices (e.g., the wireless device 802) according to corresponding RATs.

The network device 820 may include one or more antenna(s) 830 (e.g., one, two, four, or more). In embodiments having multiple antenna(s) 830, the network device 820 may perform MIMO, digital beamforming, analog beamforming, beam steering, etc., as has been described.

The network device 820 may include one or more interface(s) 832. The interface(s) 832 may be used to provide input to or output from the network device 820. For example, a network device 820 that is a base station may include interface(s) 832 made up of transmitters, receivers, and other circuitry (e.g., other than the transceiver(s) 828/antenna(s) 830 already described) that enables the base station to communicate with other equipment in a network, and/or that enables the base station to communicate with external networks, computers, databases, and the like for purposes of operations, administration, and maintenance of the base station or other equipment operably connected thereto.

The network device 820 may include an STxMP module 834. The STxMP module 834 may be implemented via hardware, software, or combinations thereof. For example, the STxMP module 834 may be implemented as a processor, circuit, and/or instructions 826 stored in the memory 824 and executed by the processor(s) 822. In some examples, the STxMP module 834 may be integrated within the processor(s) 822 and/or the transceiver(s) 828. For example, the STxMP module 834 may be implemented by a combination of software components (e.g., executed by a DSP or a general processor) and hardware components (e.g., logic gates and circuitry) within the processor(s) 822 or the transceiver(s) 828.

The STxMP module 834 may be used for various aspects of the present disclosure, for example, aspects of FIGS. 1-6, from a network device perspective.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, network device, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form described. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

The systems described herein pertain to specific embodiments but are provided as examples. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

We claim:

1. A user equipment (UE), comprising:
at least one transceiver;
multiple antenna panels or antenna ports; and
a processor configured to:
connect, via the at least one transceiver and using the multiple antenna panels or antenna ports, with multiple transmission and reception points (mTRP) for simultaneous uplink transmission over multiple panels (STxP);
transmit, via the at least one transceiver to at least one TRP of the mTRP, a UE capability report including one or more UE capabilities corresponding to each antenna panel or antenna port of the multiple antenna panels or antenna ports for the STxMP, a UE capability of the one or more UE capabilities identified by a respective UE capability index; and
in accordance with the STxMP and group based beam reporting enabled at the UE, transmit, via the at least one transceiver to the at least one TRP of the mTRP, channel state information (CSI) report including at least one UE capability index identifying one UE capability corresponding to each antenna panel or antenna port of the multiple antenna panels or antenna ports for the STxMP.

2. The UE of claim 1, wherein:
the UE capability corresponds with a maximum number of layers supported for uplink (UL) transmission associated with a first sounding reference signal (SRS) resource set and a maximum number of layers supported for UL transmission associated with a second SRS resource set;
the first SRS resource set is associated with a first TRP of the mTRP; and
the second SRS resource set is associated with a second TRP of the mTRP.

3. The UE of claim 2, wherein a total of the maximum number of layers supported for the UL transmission associated with the first SRS resource set and the maximum number of layers supported for the UL transmission associated with the second SRS resource set is less than or equal to four layers.

4. The UE of claim 2, wherein:
the UE capability index is selected from a list of UE capability indexes, each UE capability index of the list of UE capability indexes is associated with a unique combination of the maximum number of layers supported for the uplink (UL) transmission associated with the first SRS resource set and the maximum number of layers supported for the UL transmission associated with the second SRS resource set; and
the list of UE capability indexes is reported from the UE to the network.

5. The UE of claim 2, wherein:
the first SRS resource set and the second SRS resource set are configured at the UE based on the UE capability corresponding to each antenna panel or antenna port of the multiple antenna panels or antenna ports for the STxMP.

6. The UE of claim 5, wherein:
a value of an SRS resource set indicator identifies one or more antenna panels or antenna ports associated with the first SRS resource set and/or the second SRS resource set selected for UL transmission; and
the SRS resource set indicator is used to indicate a switching between UL transmission to a single TRP (sTRP) or to the mTRP.

7. The UE of claim 6, wherein:
an SRS resource set indicator includes:
a first field or a first bit that corresponds to the first SRS resource set; and
a second field or a second bit that corresponds to the second SRS resource set; and
the first field or the first bit set to 0 and the second field or the second bit set to 1, or vice versa, correspond with the UL transmission to the sTRP; or
the first field or the first bit, and the second field or the second bit both set to 1 correspond with the UL transmission to the mTRP.

8. The UE of claim 5, wherein the maximum number of layers supported for each configured SRS resource set is configured at the UE.

9. The UE of claim 8, wherein the maximum number of layers supported for each configured SRS resource set and one or more SRS resource sets are configured at the UE using a radio resource control (RRC) signaling.

10. The UE of claim 2, wherein:
the processor is configured to:
receive scheduling downlink control information (DCI); and
determine whether a physical uplink shared channel (PUSCH) scheduled by the scheduling DCI corresponds with UL transmission to a single TRP (sTRP) or to the mTRP.

11. The UE of claim 10, wherein:
based on a value of an SRS resource set indicator in the received scheduling DCI for the UL transmission to the sTRP, one SRS resource set is used for the UL transmission and another SRS resource set is reserved or unused.

12. The UE of claim 10, wherein:
in accordance with the UE supporting the maximum number of layers across at least two panels of the multiple antenna panels or antenna ports, a bit or a field corresponding to each SRS resource set indicator of each panel is concatenated to indicate a SRS resource set for the UL transmission to the sTRP.

13. The UE of claim 1, wherein:
the CSI report further includes:
a respective channel state information reference signal (CSI-RS) resource set information corresponding to at least two TRPs of the mTRP; and
a reference signal received power (RSRP) corresponding to a channel state information reference signal resource indicator (CRI) of the at least two TRPs of the mTRP.

14. A user equipment (UE), comprising:
at least one transceiver;
multiple antenna panels or antenna ports; and
a processor configured to:
connect, via the at least one transceiver and using the multiple antenna panels or antenna ports, with multiple transmission and reception points (mTRP) for simultaneous uplink transmission over multiple panels (STxP);
in accordance with the STxMP and group based beam reporting enabled at the UE, transmit, via the at least one transceiver to at least one TRP of the mTRP, channel state information (CSI) report including at least one UE capability index identifying one UE capability corresponding to each antenna panel or antenna port of the multiple antenna panels or antenna ports for the STxMP; and
receive multiple beam failure detection (BFD) reference signal (RS) sets, each BFD RS set of the multiple BFD RS sets having a respective BFD RS set index, the respective BFD RS set index identifies a TRP of the mTRP.

15. The UE of claim 14, wherein:
the TRP of the mTRP is identified based on an association between a BFD RS set index and a TRP identification (TRP-ID).

16. The UE of claim 14, wherein:
the processor is configured to:
update transmission configuration indicator (TCI) states corresponding to the TRP associated with a BFD RS set index in a received beam failure recovery response (BFRR).

17. A network device of a radio access network (RAN), comprising:
a transceiver; and
a processor configured to:
connect, via the transceiver, with a user equipment (UE) that is configured for simultaneous uplink transmission over multiple panels (STxMP) with multiple transmission and reception points (mTRP);
receive, via the transceiver from the UE, a UE capability report including one or more UE capabilities corresponding to each antenna panel or antenna port of multiple antenna panels or antenna ports of the UE for the STxMP to the mTRP, a UE capability of the one or more UE capabilities identified by a respective UE capability index;
based on the received UE capability for the STxMP with the mTRP, enable group based beam reporting at the UE; and
receive, via the transceiver from the UE, channel state information (CSI) report including at least one UE capability index identifying one UE capability corresponding to each antenna panel or antenna port of the multiple antenna panels or antenna ports for the STxMP.

18. The network device of claim 17, wherein:
the UE capability index is selected from a list of UE capability indexes configured at the UE by the network device; and
each UE capability index of the list of UE capability indexes is associated with a unique combination of a maximum number of layers supported for uplink (UL) transmission associated with a first sounding reference signal (SRS) resource set and a maximum number of layers supported for UL transmission associated with a second SRS resource set.

19. The network device of claim 17, wherein:
the processor is configured to:
transmit, to the UE, multiple beam failure detection (BFD) reference signal (RS) sets, each BFD RS set of the multiple BFD RS sets having a respective BFD RS set index, the respective BFD RS set index identifies a TRP of the mTRP.

20. The network device of claim 19, wherein:
the processor is configured to:
transmit beam failure recovery response (BFRR) including a BFD RS set index to cause the UE to update transmission configuration indicator (TCI) states corresponding to the TRP associated with the BFD RS set index in the BFRR.
